(19) United States
(12) Patent Application Publication
(10) Pub. No.: US 2020/0142962 A1
(43) Pub. Date: May 7, 2020

(54) SYSTEMS AND METHODS FOR CONTENT FILTERING OF PUBLICATIONS

(71) Applicant: JPMorgan Chase Bank, N.A., New York, NY (US)

(72) Inventors: David D. Lin, Tuxedo Park, NY (US); Kent Jiatian Zheng, London (GB); Kai Shen, Bromley (GB); Yazann Romahi, Oxford (GB); Wei Victor Li, London (GB); Mustafa Berkan Sesen, London (GB); Joe Staines, New York, NY (US)

(21) Appl. No.: 16/182,765

(22) Filed: Nov. 7, 2018

(51) Int. Cl. G06F 17/27; G06N 3/08

(52) U.S. Cl. CPC G06F 17/2785; G06N 3/08; G06F 17/274

(57) ABSTRACT

Systems and methods for content filtering based on relevance of publications are disclosed. In one embodiment, in an information processing apparatus comprising at least one computer processor, a method for content filtering of publications may include: (1) receiving a trained neural network, the trained neural network being trained to predict a relevance probability of a publication and comprising a plurality of word vectors, each word vector having a set of trained weights; (2) receiving a publication for evaluation; (3) identifying textual data in the publication; (4) identifying a plurality of sentences in the textual data; (5) identifying a plurality of words in the plurality of sentences; (6) transforming each of the words into word vectors; (7) applying the trained neural network to predict the relevance probability for the publication using the word vectors; and (8) outputting the relevance probability for the publication.

### BACKGROUND OF THE INVENTION

### 1. Field of the Invention

This technology generally relates to content filtering and, more particularly, to systems and methods for content filtering based on relevance of publications.

### 2. Description of the Related Art

Publications, such as news publications, newsletters, news websites, blogs, corporate reports and filings, play an important role in both large and small organizations. On a regular day, an organization may receive thousands of news publications from multiple content provider devices. Unfortunately, only a few may be of interest to the business task at hand.

Organizations often have particular interest in publications of specific topic, such as mergers and acquisitions related news, stock market related news, a company and/or organization specific related news, or product specific news, although other types of topics may be interest. The quality of the results of those searches is based on the keyword search terms and databases used, and, as a result, there is a good chance of missing a publication of interest. Thus, identification of publications of interest using keyboard-based search is often inefficient, time consuming, and prone to error.

### SUMMARY OF THE INVENTION

Systems and methods for content filtering based on relevance of publications are disclosed. In one embodiment, in an information processing apparatus comprising at least one computer processor, a method for content filtering of publications may include: (1) receiving a trained neural network, the trained neural network being trained to predict a relevance probability of a publication and comprising a plurality of word vectors, each word vector having a set of trained weights; (2) receiving a publication for evaluation; (3) identifying textual data in the publication; (4) identifying a plurality of sentences in the textual data; (5) identifying a plurality of words in the plurality of sentences; (6) transforming each of the words into word vectors; (7) applying the trained neural network to predict the relevance probability for the publication using the word vectors; and (8) outputting the relevance probability for the publication.

In one embodiment, the method may further include tagging each of the words with a part of speech information. In one embodiment, the plurality of words may be tagged with the part of speech using a part-of-speech tagging algorithm. The tagged words may be transformed into word vectors.

In one embodiment, the publication for evaluation may include a press release, a news publication, a website, a corporate report, a corporate filing, an electronic book, etc.

In one embodiment, the textual data in the publication may be identified using a character recognition algorithm.

In one embodiment, the plurality of sentences may be identified using punctuation in the textual data.

In one embodiment, the tagged words may be transformed into word vectors by creating a vocabulary of tagged words, and assigning each of the tagged words a vector of floating point numbers.

In one embodiment, the method may further include receiving an override of the relevance probability for the publication; labeling the relevance probability based on the override; and re-training the trained neural network using the publication and the override.

In one embodiment, the trained neural network may be trained by receiving a plurality of historical publications; identifying textual data in each of the historical publications; identifying a plurality of sentences in the textual data; identifying a plurality of words in the plurality of sentences; transforming each of the words into word vectors; generating the trained neural network using the word vectors; and storing the trained neural network. The trained neural network may be further trained by tagging each of the words with a part of speech information. The tagged words may be transformed into word vectors.

In one embodiment, a system for content filtering of publications may include a content provider device providing a publication to be evaluated for a relevance probability; a client device that receives the publication and the relevance probability; and a content filtering device in communication with the content provider device and the client device and comprising at least one computer processor. The content filtering device may perform the following: receive a trained neural network, the trained neural network being trained to predict a relevance probability of a publication and comprising a plurality of word vectors, each word vector having a set of trained weights; receive a publication for evaluation; identify textual data in the publication; identify a plurality of sentences in the textual data; identify a plurality of words in the plurality of sentences; transform each of the words into word vectors; apply the trained neural network to predict the relevance probability for the publication using the word vectors; and output the relevance probability for the publication.

In one embodiment, the content filtering device may tag each of the words with a part of speech information, and the tagged words may be transformed into word vectors. In one embodiment, the plurality of words may be tagged with the part of speech using a part-of-speech tagging algorithm.

In one embodiment, the publication for evaluation may include a press release, a news publication, a website, a corporate report, a corporate filing, an electronic book, etc.

In one embodiment, the textual data in the publication may be identified using a character recognition algorithm.

In one embodiment, the plurality of sentences may be identified using punctuation in the textual data.

In one embodiment, the tagged words may be transformed into word vectors by creating a vocabulary of tagged words, and assigning each of the tagged words a floating point number.

In one embodiment, the content filtering device may also receive an override of the relevance probability for the publication; labels the relevance probability based on the override; and re-train the trained neural network using the publication and the override.

A method for content filtering is implemented by one or more content filtering devices to identify textual data and non-textual data within a publication. A vector embedding is created based on the texual data. A relevance probability associated with the publication is predicted based on the trained neural network algorithm with a vector embedding layer. The publication is classified based on an indicator received in response to transmitting the predicted relevance probability.

A content filtering device includes memory comprising programmed instructions stored thereon and one or more processors configured to be capable of executing the stored programmed instructions to identify textual data and non-textual data within a publication. A vector embedding is created based on the texual data. A relevance probability associated with the publication is predicted based at least on the created vector embedding and a trained neural network algorithm. The publication is classified based on an indicator received in response to transmitting the predicted relevance probability.

A non-transitory computer readable medium has stored thereon instructions for content filtering including executable code which when executed by one or more processors causes the processors to identify textual data and non-textual data within a publication. A vector embedding is created based on the texual data. A relevance probability associated with the publication is predicted based at least on the created vector embedding and a trained neural network algorithm. The publication is classified based on an indicator received in response to transmitting the predicted relevance probability

This technology provides a number of advantages including methods, content filtering devices and non-transitory computer readable media that more efficiently and/or effectively filter news content. With this technology, identification of relevant publications is enhanced based on previously stored mappings in an optimized process to continually improve the accuracy of identifying relevant publications. This technology also provides an efficient and streamlined process of filtering news data to identify relevant news data of interest to the user quickly and accurately. Accordingly, this technology provides substantially improved content filtering and more efficient and accurate identification and classification of publications.

### BRIEF DESCRIPTION OF THE DRAWINGS

FIG. 1 is a block diagram depicting an exemplary network environment with an exemplary content filtering device according to one embodiment;

FIG. 2 is a block diagram depicting the exemplary content filtering device of FIG. 1;

FIG. 3 is a flowchart depicting an exemplary method for training the exemplary content filtering device of FIG. 1;

FIGS. 4A and 4B depict a flowchart depicting an exemplary method for predicting a relevance of publications based on the trained exemplary content filtering device of FIG. 1.

### DETAILED DESCRIPTION OF PREFERRED EMBODIMENTS

Embodiments are directed to systems and methods for content filtering of publication data. Embodiments may efficiently and effectively filter publications based on the relevance of content associated with the publications.

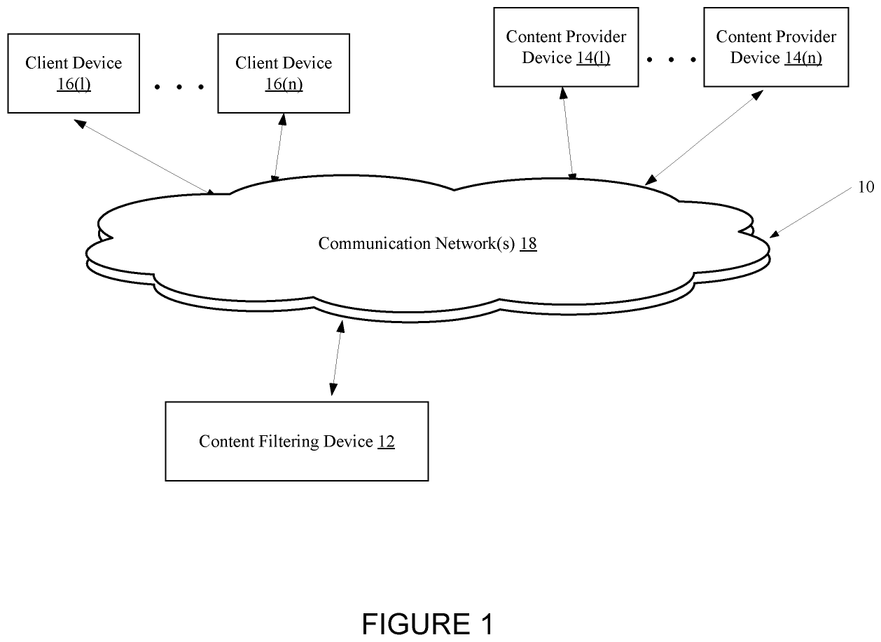

Referring to FIG. 1, an exemplary network environment 10 with an exemplary content filtering device 12 is illustrated. In one embodiment, the content filtering device 12 may be coupled, via communication network(s) 18, to client devices 16(1)-16(n) and to content provider devices 14(1). The content filtering device 12, content provider devices 14(1)-14(n), and/or client devices 16(1)-16(n) may be coupled together via other topologies as is necessary and/or desired.

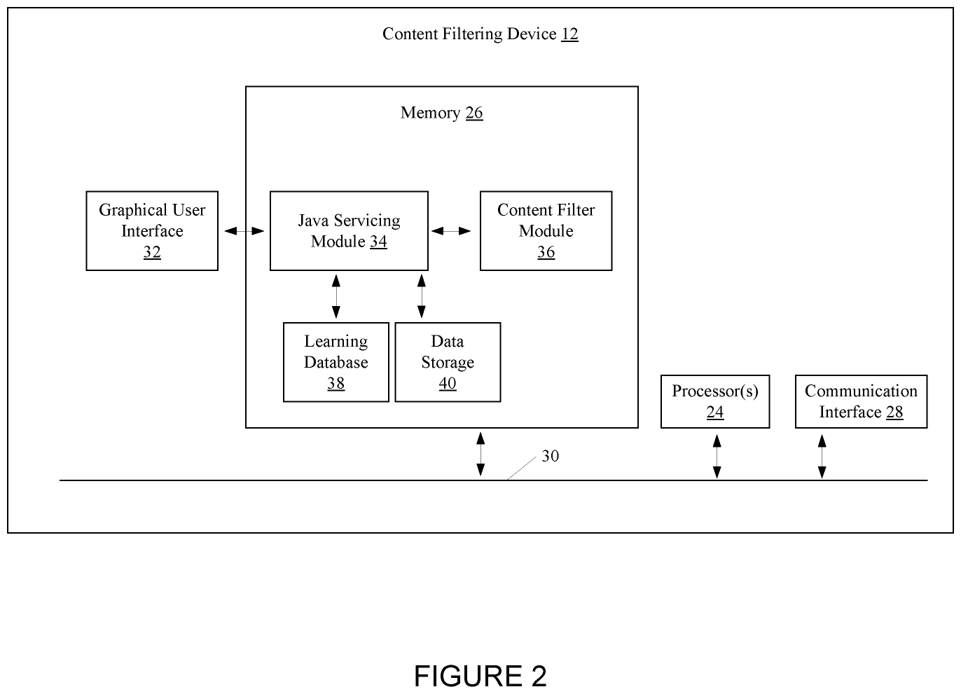

Referring to FIGS. 1-2, the content filtering device 12 may include one or more processors 24, a memory 26, a communication interface 28, which may be coupled by a bus 30 or other communication link, and a graphical user interface 32. The content filtering device 12 may include other types and/or numbers of elements in other configurations. The processor(s) 24 of the content filtering device 12 may execute programmed instructions stored in the memory 26 for the functions described and illustrated herein. The processor(s) 24 of the content filtering device 12 may include one or more CPUs or general purpose processors with one or more processing cores; for example, although other types of processor(s) may also be used.

The memory 26 may store programmed instructions for one or more aspects of the present technology as described and illustrated herein, although some or all of the programmed instructions may be stored elsewhere. A variety of different types of storage devices, such as random access memory (RAM), read only memory (ROM), hard disk, solid state drives, flash memory, or other computer readable medium which is read from and written to by a magnetic, optical, or other reading and writing system that is coupled to the processor(s) 24, may be used for the memory 26.

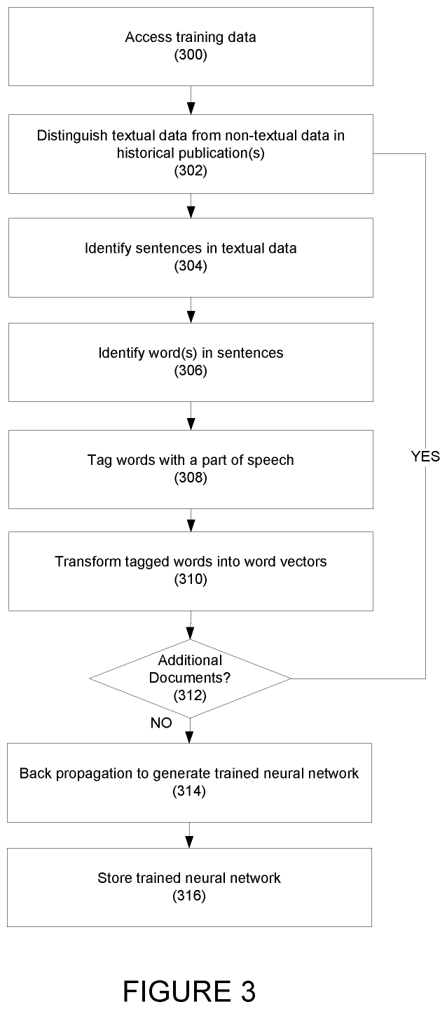

The memory 26 may store one or more computer programs or applications that may include executable instructions that, when executed by the content filtering device 12, may cause the content filtering device 12 to perform actions, such as to transmit, receive, or otherwise identify textual and non-textual data, create vector embedding and perform classifications of publications, for example, and to perform other actions described and illustrated below with reference to FIGS. 3-5. The applications may be implemented as modules or components of other applications. Further, the applications may be implemented as operating system extensions, modules, plugins, or the like.

The computer program/application may execute in a cloud-based computing environment, within or as one or more virtual machines or virtual servers that may be managed, for example, in a cloud-based computing environment. The applications and/or the content filtering device 12 itself may be located in one or more virtual servers running in a cloud-based computing environment rather than being tied to one or more specific physical network computing devices. The applications may be running in one or more virtual machines (VMs) executing on the content filtering device 12.

In one embodiment, the memory 26 may include a Java Servicing module 34, a content filter module 36, a learning database 38, and data storage 40. The memory 26 may include other policies, modules, databases, or applications, as is necessary and/or desired.

The graphical user interface (GUI) 32 may couple the client devices 16(1)-16(n) and the Java Servicing module 34, and may generate a user interface to control and manage publications. For example, the GUI 32 may generate and present a user interface at the client devices 16(1)-16(n) and/or at the content filtering device 12 that may display, control and manage classifications of publications. Further, the GUI 32 may provide controls that may be used to manage a classification associated with each publications. For example, GUI 32 may receive an invalidation identifier and may change the classification of publications from “relevant” to “not relevant,” or may receive validation identifier change the classification of the publications from “not relevant” to “relevant.” Any other suitable classification or classification(s) may be used as is necessary and/or desired. Other number and/or types of controls may also be provided as is necessary and/or desired. These classifications may be used for future training purposes to improve the accuracy of the model.

In one embodiment, the Java Servicing (JS) module 34 may receive publications from the content provider devices 14(1)-14(n) and may manage the communication of publications among the GUI 32, the content filter module 36, the vector database 38, the classification database 40, and the data storage 42. For example, the JS module 34 may be implemented using a JavaScript algorithm or script, although other algorithms or scripts may be used.

The JS module 34 may also receive classified publications from the content filter module 36, and may transmit the received classified publications to the GUI 32 and the data storage 40. The JS module 34 may store a list of entries corresponding to the received classified publications in the data storage 40 upon receiving the classified publications from the content filter module 36.

The JS module 34 may receive vector embedding including word vectors corresponding to each tagged word in the publications from the content filter module 36 and may store the received vector embedding in the learning database 38.

Other types of communications may also be managed by the JS module 34.

The content filter module 36 may classify publications as “relevant” or “not relevant,” or using any other suitable classification. The content filter module 36 may identify textual and non-textual data within the received publications and create a vector embedding. The content filter module 36 also may determine a relevance probability associated with each of the received publications.

In addition, for each word vector, the JS module 34 may store an entry corresponding to the word vector location in the vector embedding.

The communication interface 28 may couple the content filtering device 12, the content provider devices 14(1)-14(n), and/or the client devices 16(1)-16(n) using communication network(s) 18 and/or direct connections. Other types and/or numbers of communication networks or systems with other types and/or numbers of connections and/or configurations to other devices and/or elements may also be used as is necessary and/or desired.

In one embodiment, the communication network(s) 18 may include local area network(s) (LAN(s)) or wide area network(s) (WAN(s)), and may use TCP/IP over Ethernet and industry-standard protocols, although other types and/or numbers of protocols and/or communication networks may be used. The communication networks 18 may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The content filtering device 12 may be a standalone device, or it may be integrated with one or more other devices or apparatuses. For example, the content filtering device 12 may include, or be hosted by, one of the content provider devices 14(1)-14(n). Other arrangements may be used as is necessary and/or desired. Moreover, one or more of the elements of the content filtering device 12 may be in a same or a different communication network, including, for example, one or more public, private, or cloud networks.

In one embodiment, the content provider devices 14(1)-14(n) may be any suitable type of computing device that is capable of storing, serving, and/or providing publications. Each of the content provider devices 14(1)-14(n) may include one or more of processors, memory, and a communication interface, which may be coupled by a bus or other communication link, although any suitable type of network devices may be used. The content provider devices 14(1)-14(n) may also include databases to store publications, etc.

The content provider devices 14(1)-14(n) may include server devices hosting news websites provided by news providing organizations publications. Exemplary news providing organizations hosting the news websites include, Bloomberg News Portal, Reuters, Investopedia, The Wall Street Journal, the Financial Times, Consumer News and Business Channel (CNBC), Cable News Network (CNN), British Broadcasting Corporation (BBC), Yahoo News, Google News, etc.

In another example, the content provider devices 14(1)-14(n) may include, for example, server devices hosting websites provided by a content providing organization. The content providing organization hosting websites may include, for example, Wikipedia, Webopedia, Google Scholar, Institute of Electrical and Electronics Engineers (IEEE), Facebook, Twitter, etc.

The content provider devices 14(1)-14(n) may receive a request for content from the content filtering device 12, process the request for content, and return relevant publications. The request for content may originate with the client devices 16(1)-16(n), for example, from applications hosted on the client devices 16(1)-16(n), although the request for content may also originate elsewhere within the network environment 10.

In one embodiment, the client devices 16(1)-16(n) may include any type of computing device that may host applications (e.g., application servers) and may transmit requests to the content filtering device 12 for processing by the news content provider devices 14(1)-14(n). Each of the client devices 16(1)-16(n) may include a processor, a memory, and a communication interface, which may be coupled by a bus or other communication link, although other numbers and/or types of network devices could be used.

Although the exemplary network environment 10 with the content filtering device 12, content provider devices 14(1)-14(n), client devices 16(1)-16(n), and communication network(s) 18 are described and illustrated herein, other types and/or numbers of systems, devices, components, and/or elements in other topologies may be used. It is to be understood that the systems of the examples described herein are for exemplary purposes, as variations of the specific hardware and software used to implement the examples are possible, as will be appreciated by those skilled in the relevant art(s).

Referring to FIG. 3, an exemplary method for training a neural network for relevance probability prediction is disclosed according to one embodiment. In step 300, the content filtering device may access training data in response to, for example, an initialization request received from a client device. For example, the content filtering device may access the data storage to collect previously stored training data stored at the data storage. The previously stored training data may include historical publications that may be manually labeled as relevant publications, as not relevant publications, or using any other suitable classification. The content filtering device may use the manually-labeled publications to train a multi-resolution convolutional neural network (CNN) algorithm. An example of a suitable CNN algorithm is disclosed in Conneau et al., “Very Deep Convolutional Networks for Text Classification,” available at https://arxiv.org/pdf/1606.01781.pdf. The disclosure of this document is hereby incorporated, by reference, in its entirety.

For example, historical publications used for training may include press releases, news stories, websites, corporate reports and filings (e.g., financial reports associated with corporations, business filings associated with mergers and/or tax returns filings, regulatory filings, etc.), electronic books, other online publications, scanned pages of physical publications, historical websites pages etc. Other types of historical publications may be used for training as is necessary and/or desired.

In one embodiment, the textual training data may be processed in bulk, in batches, individually, or as otherwise necessary and/or desired.

In step 302, the content filtering device may use a character recognition algorithm to identify and distinguish textual data and non-textual data content in the historical publications used for training, although other manners of identifying the textual data and/or non-textual data may be used as is necessary and/or desired. Examples of non-textual include graphical images, punctuation marks (e.g., periods, commas, parentheses, etc.), numerical digits, etc. The textual data may include words and letters, etc.

In step 304, the content filtering device may identify sentences within the historical publications used for training. For example, in one embodiment, the content filtering device may identify a first period mark, and then identify the words before the first period mark as a first sentence. The content filtering device may then identify the next, or second, period mark and identify the words between the first period mark and the second period mark as a second sentence, etc.

Any other suitable method of identifying sentences may be used as is necessary and/or desired.

When the content filtering device determines that a suitable number of sentences (e.g., a threshold amount of sentences, all sentences, etc.) have been identified, the content filtering device may apply a text filtering algorithm to extract the textual data corresponding the identified sentences and filter out all non-textual data. Any other suitable filtering method or algorithm may be used as is necessary and/or desired.

Following sentence identification, in step 306, single or multiple words, n-grams, etc. may be recognized within the filtered sentences.

In step 308, the content filtering device may apply a part-of-speech (PoS) tagging algorithm to sentences to tag, or associate, each of the words in the sentences with a PoS part. The PoS parts may include, for example, nouns, pronouns, adjectives, determiners, verbs, adverbs, prepositions, conjunctions, interjections, etc. Any other suitable PoS part and/or identifiers may be used as is necessary and/or desired.

For example, if a sentence is “I went to a lot of stores but came home with only two purchases”, the PoS algorithm may identify “noun” as the PoS part for “purchases.”

In step 310, the content filtering device may transform the tagged words into corresponding word vectors. In one embodiment, the content filtering device may create a vocabulary for all the tagged words, and may store the vocabulary in the data storage. The content filtering device may then transform each of the tagged words in the vocabulary to a vector of floating point numbers, called a word vector, and may store the word vector.

In step 312, the content filtering device may determine if additional historical publications are available for review. If so, the process repeats with step 302.

If no additional historical publications are available for review, in step 314, the content filtering device may perform “back propagation,” or training, to generate a trained neural network using, for example, vector embeddings based on the word vectors or one-hot encoding using a bag-of-words technique, etc. For example, this training may be achieved by applying a gradient descent routine that iteratively attempts to minimize a loss function that quantifies the discrepancies between the manual labels and model prediction. This loss function may focus on increasing the accuracy, recall, precision, etc. of the model. An example of a suitable Gradient descent routine is described in Kingma, Diederik; Ba, Jimmy; “Adam: A Method for Stochastic Optimization,” ICLR 2015, the disclosure of which is hereby incorporated by reference in its entirety.

In one embodiment, each of the word vectors may be assigned a random initial weight (e.g., a floating point number).

In one embodiment, the neural network may include an input layer, interim convolutional and fully connected layers, and an output layer. The input layer may receive the word vectors extracted from the textual input as vector embeddings, bag-of-words, etc. The interim convolutional and fully connected layers may extract useful features from the input features. The output layer may output the relevance probability for each of the publications.

The interim convolutional layers may use various convolution sizes to extract features from local regions in the textual input. For example, a large convolution size may capture the global structure of the collection of the vector embedding previously stored in the learning database, whereas a small convolution size may capture the local details with high resolution but it does not capture the global structure. In one embodiment, the algorithm may use a combination of convolutional layers with 2, 3, and 5-word convolution sizes in order to extract both the medium scale patterns and local details from the input features in each layer.

Upon completion of the training, the content filtering device may update the initial weights assigned to the network parameters, resulting in trained weights.

In step 316 the content filtering device may store the trained neural network. The trained neural network may be stored in the learning database as, for example, a Python object, or any other suitable object in another programming language.

The trained neural network may be updated using retraining, which may be based on manual-labeled publications.

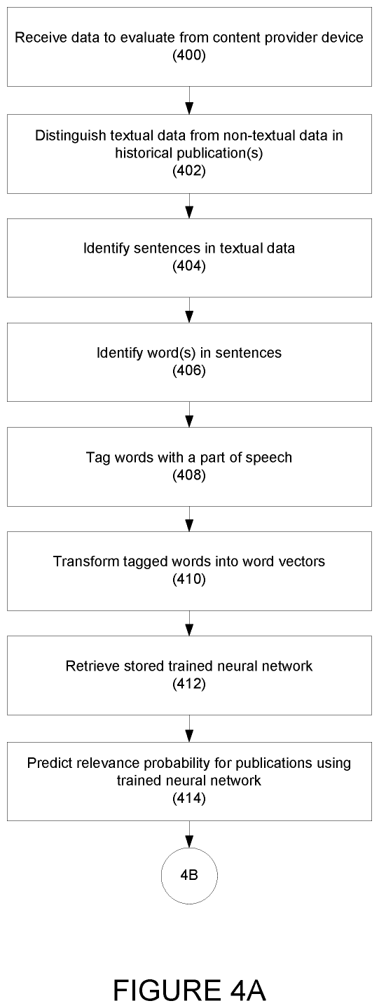

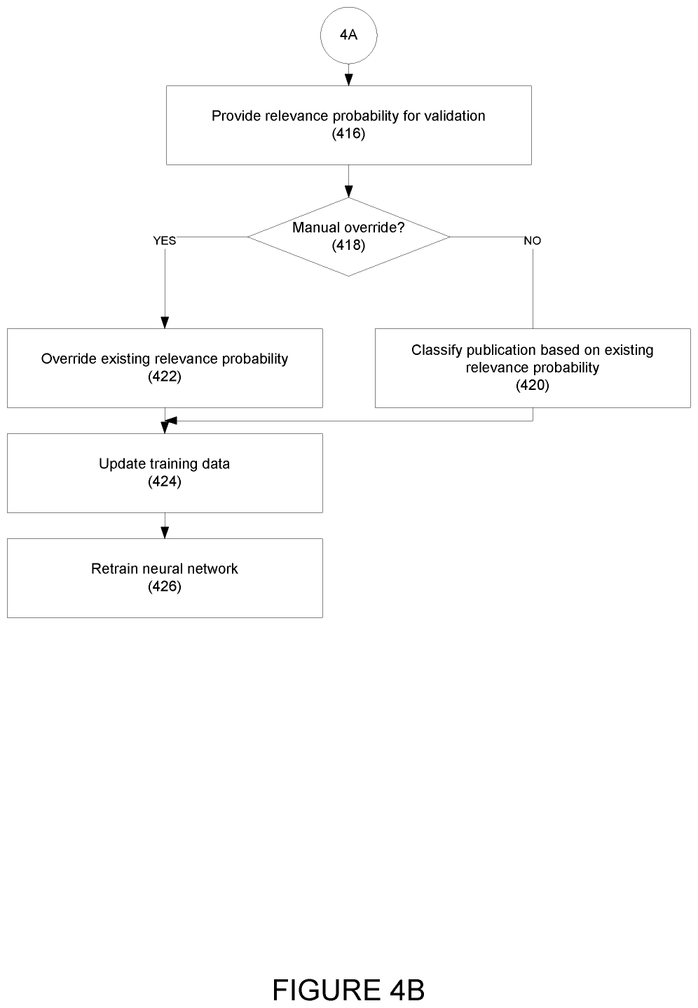

Referring to FIG. 4, an exemplary method for content filtering using a trained neural network is illustrated according to one embodiment. In step 400, the content filtering device may receive one or more publications for evaluation from a content provider device. This may be, for example, in response to a request for content sent by the content filtering device. The received publications may include, for example, website pages, corporate reports and filings, other online publications, etc.

In one embodiment, publications within a certain time period may also be requested and obtained.

In one embodiment, the content filtering device may request and obtain some or all information from one or more particular data source, within a certain trailing time period, and/or within a general category of information, such as business news. This may obtain an initial dataset that is larger than keyword searching, as the request may not be based on keywords.

In step 402, the content filtering device may apply a character recognition algorithm to identify and distinguish textual data and non-textual data in content in the one of the publications. This may be similar to step 302, above.

In step 404, the content filtering device may identify sentences in the publication. This may be similar to step 304, above.

In step 406, single or multiple words, n-grams, etc. may be recognized within the filtered sentences. This may be similar to step 306, above.

In step 408, the content filtering device may apply a part-of-speech (PoS) tagging algorithm to sentences to tag, or associate, each of the words in the sentences with a PoS part. This may be similar to step 308, above.

In step 410, the content filtering device may transform the tagged words into corresponding word vectors, or may apply a bag-of-words technique. This may be similar to step 310, above.

In step 412, the content filtering device may retrieve the stored trained neural network (e.g., the neural network stored in step 316, above).

In step 414, the content filtering device may predict a relevance probability for each of the publications using the previously stored trained neural network, including the trained weights assigned to the word vectors.

As discussed above, the trained neural network may include an input layer, interim convolutional and fully connected layers, and an output layer. The input layer may receive the word vectors extracted from the textual input as vector embeddings. The interim convolutional and fully connected layers may extract useful features from the input features. The output layer may output the relevance probability for each of the publications.

For example, the output layer may determine the relevance probability that a publication is relevant P(Relevant)=0.7 and a probability that the publication is not relevant P(Not relevant)=0.3. The determined probabilities quantify the chances of the publications being relevant or not relevant publications.

In step 416, the content filtering device may transmit the relevance probability associated with each of the publications to a client device for validation.

In step 418, if a manual overwrite indicator is received from one of the client devices (e.g., a change to the labeling of the publication), in step 422, the content filtering device may override the existing relevance probability and label the publication as relevant or non-relevant based on the override. In step 424, the content filtering device may update the training data by adding the manually-labeled publications with their manual classifications to the data storage. The manually-labeled publications and their manual classifications may be used by the content filtering device to re-train the stored neural network.

In one embodiment, the re-training may be performed periodically, on demand, or as necessary and/or desired.

If, in step 418, no manual overwrite indicator is received, in step 420, the content filtering device may classify the publications based on the existing relevance probability.

In one embodiment, the content filtering device may use a pre-defined threshold to classify the publications. For example, for a pre-defined threshold of P(Relevant)=0.65, the content filtering device may classify a publication as a relevant publication when the relevance probability of the publication is equal to or exceeds 0.65, and as not relevant when the publication has a relevance probability of P(Relevant) of less than 0.65. This threshold is exemplary only, and may vary as is necessary and/or desired.

The publication may be stored in the data storage along with the assigned classification.

As additional publications are received, the process may be repeated.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for content filtering of publications, comprising:
in an information processing apparatus comprising at least one computer processor:
receiving a trained neural network, the trained neural network being trained to predict a relevance probability of a publication and comprising a plurality of word vectors, each word vector having a set of trained weights;
receiving a publication for evaluation;
identifying textual data in the publication;
identifying a plurality of sentences in the textual data;
identifying a plurality of words in the plurality of sentences;
transforming each of the words into word vectors;
applying the trained neural network to predict the relevance probability for the publication using the word vectors; and
outputting the relevance probability for the publication.

2. The method of claim 1, further comprising:
tagging each of the words with a part of speech information;
wherein the tagged words are transformed into word vectors.

3. The method of claim 1, wherein the publication for evaluation comprises at least one of a press release, a news publication, a website, a corporate report, a corporate filing, and an electronic book.

4. The method of claim 1, wherein the textual data in the publication is identified using a character recognition algorithm.

5. The method of claim 1, wherein the plurality of sentences are identified using punctuation in the textual data.

6. The method of claim 2, wherein the plurality of words are tagged with part of speech information using a part-of-speech tagging algorithm.

7. The method of claim 1, wherein the tagged words are transformed into word vectors by creating a vocabulary of tagged words, and assigning each of the tagged words a floating point number.

8. The method of claim 1, further comprising:
receiving an override of the relevance probability for the publication;
labeling the relevance probability based on the override; and
re-training the trained neural network using the publication and the override.

9. The method of claim 1, wherein the trained neural network is trained by:
receiving a plurality of historical publications;
identifying textual data in each of the historical publications;
identifying a plurality of sentences in the textual data;
identifying a plurality of words in the plurality of sentences;
transforming each of the words into word vectors;
generating the trained neural network using the word vectors; and
storing the trained neural network.

10. The method of claim 9, wherein the trained neural network is further trained by
tagging each of the words with a part of speech information;
wherein the tagged words are transformed into word vectors.

11. A system for content filtering of publications, comprising:
a content provider device providing a publication to be evaluated for a relevance probability;
a client device that receives the publication and the relevance probability; and
a content filtering device in communication with the content provider device and the client device and comprising at least one computer processor, the content filtering device performing the following:
receive a trained neural network, the trained neural network being trained to predict a relevance probability of a publication and comprising a plurality of word vectors, each word vector having a set of trained weights;
receive a publication for evaluation;
identify textual data in the publication;
identify a plurality of sentences in the textual data;
identify a plurality of words in the plurality of sentences;
transform each of the words into word vectors;
apply the trained neural network to predict the relevance probability for the publication using the word vectors; and
output the relevance probability for the publication.

12. The system of claim 11, wherein the content filtering device further tags each of the words with a part of speech information, and the tagged words are transformed into word vectors.

13. The system of claim 11, wherein the publication for evaluation comprises at least one of a press release, a news publication, a website, a corporate report, a corporate filing, and an electronic book.

14. The system of claim 11, wherein the textual data in the publication is identified using a character recognition algorithm.

15. The system of claim 11, wherein the plurality of sentences are identified using punctuation in the textual data.

16. The system of claim 12, wherein the plurality of words are tagged with a part of speech using a part-of-speech tagging algorithm.

17. The system of claim 11, wherein the tagged words are transformed into word vectors by creating a vocabulary of tagged words, and assigning each of the tagged words a vector of floating point numbers.

18. The system of claim 11, wherein the content filtering device further:
receives an override of the relevance probability for the publication;
labels the relevance probability based on the override; and
re-trains the trained neural network using the publication and the override.
